(19) United States
(12) Patent Application Publication
(10) Pub. No.: US 2026/0021414 A1
(43) Pub. Date: Jan. 22, 2026

(54) EVENT MANAGEMENT DEVICE, EVENT MANAGEMENT PROGRAM, AND EVENT MANAGEMENT SYSTEM

(71) Applicant: BANDAI CO., LTD., Tokyo (JP)

(72) Inventors: Yushiro Uehara, Tokyo (JP); Yusaku Kubota, Tokyo (JP)

(21) Appl. No.: 19/277,192

(22) Filed: Jul. 22, 2025

(30) Foreign Application Priority Data
Jul. 22, 2024 (JP) 2024-117074

(51) Int. Cl. A63F 13/79; H04W 68/00

(52) U.S. Cl. CPC A63F 13/79; H04W 68/00

(57) ABSTRACT

An event management device is connected to be able to communicate with user terminals. The event management device includes a management unit, a notification unit, and a control unit. The management unit is able to manage a status of a user. The management unit is able to notify the user of a message. The control unit is able to control the management unit and the notification unit. The control unit is able to notify of a message in accordance with the status of the user.

### CROSS REFERENCE TO RELATED APPLICATIONS

This application claims priority to and the benefit of Japanese Application No. 2024-117074. filed Jul. 22, 2024, the contents which are hereby incorporated by reference in its entirety.

### BACKGROUND

### Technical Field

The present disclosure relates to an event management device, an event management program, and an event management system.

### Description of the Related Art

In the related art, a communication method of transmitting a message from a member of a chat service to a non-member has been proposed for a technology for transmitting and receiving a message using an information processing terminal (for example, JP 2014-006870 A).

There is known an event management device that manages, for face-to-face events such as competitive games using physical cards, acceptance of participation applications, drawing participants by lottery, participation confirmation in an event venue, transmission of guidance messages, and the like.

### BRIEF SUMMARY

For users who wish to participate in events, convenience is desirable, and there is room for further improvement in this respect.

One object of the present invention is to provide an event management device, an event management program, and an event management system capable of improving user convenience.

An event management device according to an aspect of the present invention is an event management device connected to be able to communicate with a user terminal. The event management device includes: a management unit configured to be able to manage a status of a user; a notification unit configured to be able to notify a user of a message; and a control unit configured to be able to control the management unit and the notification unit. The control unit performs control such that a message in accordance with the status of the user is notifiable.

An event management program according to another aspect of the present invention is an event management program for a computer connected to be able to communicate with a user terminal. The program causes the computer to function as: a management unit configured to be able to manage a status of a user; a notification unit configured to be able to notify a user of a message; and a control unit configured to be able to control the management unit and the notification unit. The control unit performs control such that a message in accordance with the status of the user is notifiable.

An event management system according to an aspect of the present invention includes an event management device and a user terminal.

According to one aspect of the present invention, it is possible to provide an event management device, an event management program, and an event management system capable of improving user convenience.

### BRIEF DESCRIPTION OF THE DRAWINGS

FIG. 1 is a diagram illustrating an example of an event management system according to an embodiment;

FIG. 2 is a diagram illustrating an example of a hardware configuration of the event management device;

FIG. 3 is a diagram illustrating an example of a hardware configuration of a user terminal;

FIG. 4 is a diagram illustrating an example of functional blocks of the event management device; and

FIG. 5 is a sequence diagram illustrating an example of a process in the event management system.

### DETAILED DESCRIPTION OF VARIOUS EMBODIMENTS

Hereinafter, aspects of an event management device, an event management program, and an event management system according to an aspect of the present disclosure will be described with reference to the drawings.

### Event Management System 1 in Embodiment

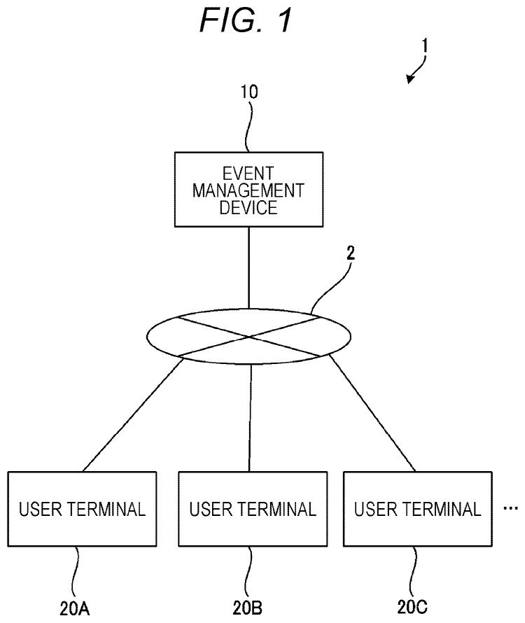

FIG. 1 is a diagram illustrating an example of an event management system 1 according to an embodiment. The event management system 1 includes an event management device 10 and user terminals 20A, 20B, 20C, . . . The event management device 10 and the user terminals 20A, 20B, 20C, . . . can communicate with each other via a network 2. The network 2 is, for example, a wide area network (WAN) such as the Internet.

For example, in a face-to-face event, the event management device 10 performs a management process such as acceptance of participation applications, drawing participants by lottery, participation confirmation in an event venue, and transmission of guidance messages. The face-to-face event is, for example, an event such as a competitive game using a physical card (a physical card made of resin or paper). The event management device 10 may include, for example, a physical server device or a virtual server.

### Hardware Configuration of Event Management Device 10>

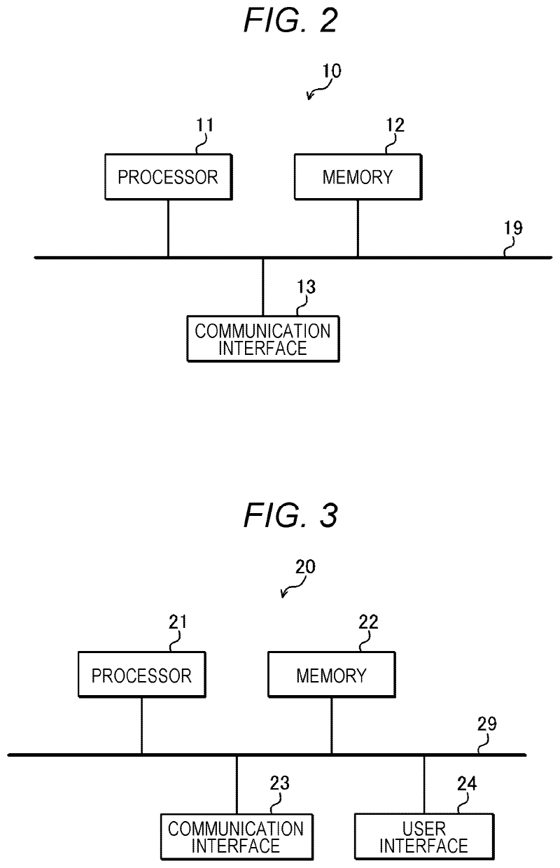

FIG. 2 is a diagram illustrating an example of a hardware configuration of the event management device 10. For example, as illustrated in FIG. 1, the event management device 10 illustrated in FIG. 1 includes a processor 11, a memory 12, and a communication interface 13. The processor 11, the memory 12, and the communication interface 13 are connected by, for example, a bus 19.

The processor 11 is a circuit that performs signal processing and is, for example, a central processing unit (CPU) that controls the entire event management device 10. The processor 11 may be implemented by another digital circuit such as a field programmable gate array (FPGA) or a digital signal processor (DSP). The processor 11 may be implemented by combining a plurality of digital circuits.

The memory 12 includes, for example, a main memory and an auxiliary memory. The main memory is, for example, a random access memory (RAM). The main memory is used as a work area of the processor 11.

The auxiliary memory is, for example, a nonvolatile memory such as a magnetic disk, an optical disc, or a flash memory. The auxiliary memory stores various programs for operating the event management device 10. The program stored in the auxiliary memory is loaded to the main memory and is executed by the processor 11.

The auxiliary memory may also include a portable memory that is removable from the event management device 10. Examples of the portable memory include a memory card such as a universal serial bus (USB) flash drive or a secure digital (SD) memory card, and an external hard disk drive.

The communication interface 13 is a communication interface that communicates with the outside of the event management device 10 (for example, the network 2). The communication interface 13 is controlled by the processor 11.

### Hardware Configuration of User Terminal 20

FIG. 3 is a diagram illustrating an example of a hardware configuration of the user terminal 20. Each of the user terminals 20A, 20B, 20C, . . . illustrated in FIG. 1 is, for example, the user terminal 20 illustrated in FIG. 3. For example, as illustrated in FIG. 2, the user terminal 20 includes a processor 21, a memory 22, a communication interface 23, and a user interface 24. The processor 21, the memory 22, the communication interface 23, and the user interface 24 are connected by, for example, a bus 29.

The processor 21 is a circuit that performs signal processing and is, for example, a CPU that controls the entire user terminal 20. The processor 21 may be implemented by another digital circuit such as an FPGA or a DSP. The processor 21 may be implemented by combining a plurality of digital circuits.

The memory 22 includes, for example, a main memory and an auxiliary memory. The main memory is, for example, a RAM. The main memory is used as a work area of the processor 21.

The auxiliary memory is, for example, a nonvolatile memory such as a magnetic disk, an optical disc, or a flash memory. The auxiliary memory stores various programs for operating the user terminal 20. The program stored in the auxiliary memory is loaded to the main memory and is executed by the processor 21.

The auxiliary memory may include a portable memory that is removable from the user terminal 20. Examples of the portable memory include a memory card such as a USB flash drive or an SD memory card, and an external hard disk drive.

The communication interface 23 is a communication interface that communicates with the outside of the user terminal 20 (for example, the network 2). The communication interface 23 is controlled by the processor 21.

The user interface 24 includes, for example, an input device that receives an operation input from a user and an output device that outputs information to the user. The input device can be configured with. for example, a key (for example, a keyboard), a remote controller, or the like. The output device can be configured with, for example, a display, a speaker, or the like. The input device and the output device may be configured by a touch panel or the like. The user interface 24 is controlled by the processor 21.

### Functional Block of Event Management Device 10

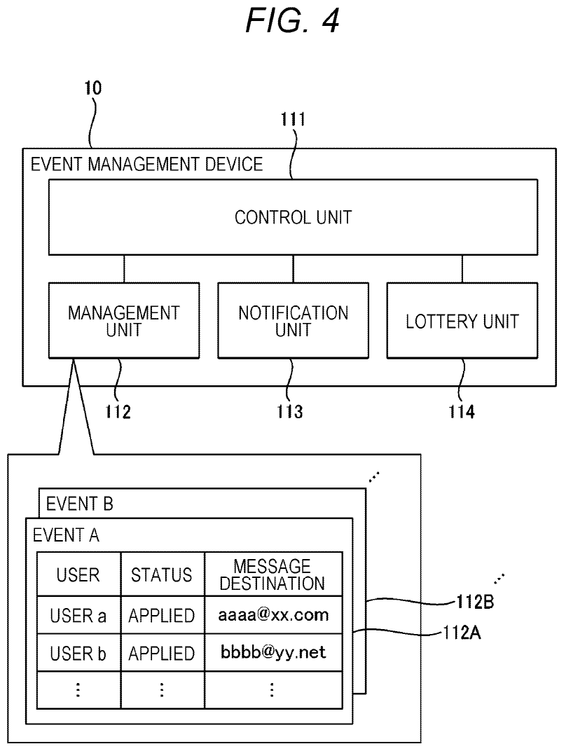

FIG. 4 is a diagram illustrating an example of functional blocks of the event management device 10. As illustrated in FIG. 4, the event management device 10 includes, for example, a control unit 111, a management unit 112, a notification unit 113, and a lottery unit 114. The control unit 111, the notification unit 113, and the lottery unit 114 are configured by, for example, the processor 11 that executes a program as illustrated in FIG. 2. The management unit 112 includes, for example, the memory 12 (for example, a nonvolatile memory) illustrated in FIG. 2.

The control unit 111 can control the management unit 112, the notification unit 113, and the lottery unit 114. The control unit 111 is an example of a control unit according to the present invention.

The management unit 112 can manage a status of the user under the control of the control unit 111. The management unit 112 is an example of a management unit according to the present invention. The user is a user of the event management device 10, that is, a user who can participate in an event managed by the event management device 10 and is, for example, an owner of each of the user terminals 20A, 20B, 20C, . . . .

The notification unit 113 is able to notify the user of a message under the control of the control unit 111. The notification unit 113 is an example of a notification unit according to the present invention. The message is, for example, a notification message for the user transmitted to a user terminal (for example, user terminals 20A, 20B, 20C, . . . ) possessed by users. For example, the message is an electronic mail, a short message service (SMS) message, a chat message, a social networking service (SNS) message, or the like.

The lottery unit 114 can execute an extraction process of selecting a user permitted to participate in an event among users who have made applications for the event under the control of the control unit 111. The lottery unit 114 is an example of a lottery unit according to the present invention.

### User Registration Table

For each event (Event A, Event B, . . . ) managed by the event management device 10, the management unit 112 stores user registration tables 112A, 112B, . . . in which users who have made applications for the event are registered. The user registration tables 112A, 112B, . . , are not limited to be stored in the management unit 112, and may be stored in a device that can be accessed by the management unit 112 and is outside of the event management device 10.

The user registration table 112A is a table related to Event A. In the user registration table 112A, the status and the message destination are associated with each user of whom an application for Event A has been made. The status is a state of the user which has a plurality of stages. The status of the user is set to “Applied” at a time point at which the user is registered in the user registration table 112A, that is, at a time point at which the application from the user to Event A is accepted. “Applied” is an example of a first stage according to the present invention. A message destination of a user is a destination of a message for the user. As an example, when the message is an email, the message destination is an email address.

The user registration table 112B is a table regarding Event B different from Event A. A data structure of the user registration table 112B is similar to that of the user registration table 112A.

### Process in Event Management System 1

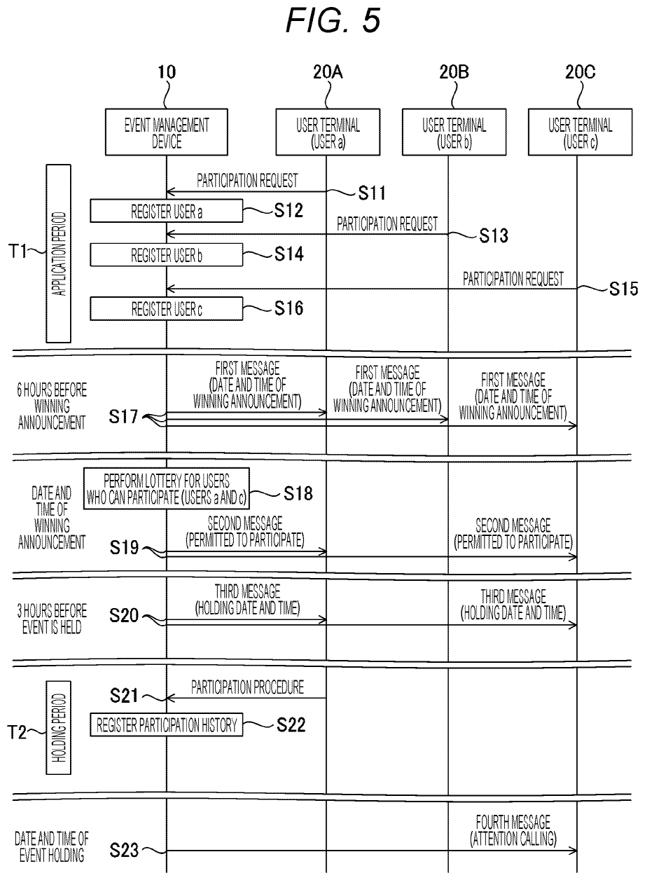

FIG. 5 is a sequence diagram illustrating an example of a process in the event management system 1. In the event management system 1, for example, the process illustrated in FIG. 5 is performed for each event managed by the event management device 10. Here, a process performed for Event A by the event management device 10 will be described. For Event A, an application period T1, a date and time of winning announcement, and a holding period T2 are determined in advance.

The application period T1 is an application period for participation in Event A. In the application period T1, the event management device 10 receives participation requests from the user terminals 20A, 20B, 20C, . . .

In this example, it is assumed that the user terminal 20A first transmits a participation request to the event management device 10 based on an operation by User a who possesses the user terminal 20A (step S11). The participation request includes information indicating that the user wishes to participate in Event A, identification information (a user ID, a name, and the like) of User a, and a message destination of User a. Subsequently, the event management device 10 registers User a based on a participation request from the user terminal 20A (step S12). Specifically, the event management device 10 registers the identification information of User a, the message destination of User a, and the status “Applied” in the user registration table 112A in association with each other.

Subsequently, it is assumed that the user terminal 20B transmits a participation request to the event management device 10 based on an operation by User b who possesses the user terminal 20B (step S13). The participation request includes information indicating that the user wishes to participate in Event A, identification information (such as a user ID and a name) of User b, and a message destination of User b. Subsequently, the event management device 10 registers User b based on the participation request from the user terminal 20B (step S14). Specifically, the event management device 10 registers the identification information of User b, the message destination of User b, and the status “Applied” in the user registration table 112A in association with each other.

Subsequently, it is assumed that the user terminal 20C transmits a participation request to the event management device 10 based on an operation by User c who possesses the user terminal 20C (step S15). The participation request includes information indicating that the user wishes to participate in Event A, identification information (such as a user ID and a name) of User c, and a message destination of User b. Subsequently, the event management device 10 registers User c based on the participation request from the user terminal 20C (step S16). Specifically, the event management device 10 registers the identification information of User c, the message destination of User c, and the status “Applied” in the user registration table 112A in association with each other.

The event management device 10 may transmit a message indicating that the registration has been accepted to the user terminals 20A, 20B, and 20C in steps S12, S14, and S16, respectively.

Next, when it is 6 hours before the date and time of the winning announcement of Event A, the event management device 10 transmits a first message to message destinations of the users (in this example. Users a, b, and c) who have been registered in the user registration table 112A and have the status “Applied” (step S17). 6 hours before is an example of the first hour before according to the present invention. The first message includes the date and time of winning announcement of Event A.

In this example, the user terminal 20A is able to receive a message to a message destination corresponding to User a, the user terminal 20B is able to receive a message to a message destination corresponding to User b, and the user terminal 20C is able to receive a message to a message destination corresponding to User c. Accordingly, the first message is received by the user terminals 20A, 20B, and 20C, and content of the first message is notified to Users a, b, and c by displaying a screen or the like.

Accordingly, User a, b, and c can know the date and time of the winning announcement of Event A a certain period of time (in this example, six hours) before the date and time of the winning announcement of Event A. Therefore, for example, it is possible to inhibit Users a, b, and c from accessing a service-side system (for example, the event management device 10) in order to confirm a result of the winning announcement and a date and time of winning announcement before the date and time of winning announcement of Event A, and to inhibit an increase in load and network traffic in the service-side system.

Subsequently, at the date and time of the winning announcement of Event A, the event management device 10 performs lottery for selecting the user permitted to participate in Event A (step S18). For example, the maximum number of participants is predetermined for Event A, and the event management device 10 randomly selects users not exceeding the maximum number of participants of Event A from the users registered in the user registration table 112A and having the status “Applied”. In this example, it is assumed that Users a and b among the Users a, b, and c are selected (won) as the users permitted to participate in Event A. In this case, the event management device 10 changes the statuses of Users a and b in the user registration table 112A from “Applied” to “Permitted to participate”. “Permitted to participate” is an example of the second stage of the present invention.

Subsequently, the event management device 10 transmits the second message to the message destinations of the users (Users a and c in this example) registered in the user registration table 112A and having the status of “Permitted to participate” (step S19). The second message includes information indicating that participation in Event A is permitted (won). In this example, the second message is received by the user terminals 20A and 20C, and Users a and c are notified of content of the second message by displaying a screen or the like.

Accordingly. Users a and c can know that the participation in Event A is permitted (won). Therefore, for example, it is possible to inhibit Users a, b, and c from accessing the service-side system (for example, the event management device 10) in order to confirm the result of the winning announcement and to inhibit an increase in load and network traffic in the service-side system.

Subsequently, when 3 hours before Event A is held, the event management device 10 transmits a third message to the message destinations of the users (Users a and c in this example) registered in the user registration table 112A and having the status of “Permitted to participate” (step S20). 3 hours before is an example of a second time before according to the present invention. The third message includes information indicating the holding date and time of Event A (for example, a holding period T2). In this example, the third message is received by the user terminals 20A and 20C, and Users a and c are notified of the content of the third message by displaying a screen or the like.

Accordingly. Users a and c can confirm the date and time of Event A a certain period of time (3 hours in this example) before the date and time of Event A. Therefore, for example, it is possible to inhibit Users a and c from accessing a service-side system (for example, the event management device 10) in order to confirm the date and time of Event A, and to inhibit an increase in load and network traffic in the service-side system.

Even if Users a and c forget to hold Event A, it is possible to remind the users of the holding of Event A a certain period of time (3 hours in this example) before the holding date and time of Event A. Therefore, it is possible to inhibit the users from not participating in Event A due to forgetting to hold Event A, to improve efficiency of holding the event, and to inhibit the increase in the load and the network traffic in the service-side system (for example, the event management device 10).

In the holding period T2 of Event A, the event management device 10 receives a participation procedure of each user that is registered in the user registration table 112A and has the status of “Permitted to participate”. The participation procedure is performed, for example, by the user who arrives at the venue of Event A and performs an operation or the like with an information terminal that is installed in the venue and can communicate with the event management device 10. In this example, it is assumed that only User a between Users a and c of which the status is “Permitted to participate” has performed the participation procedure in the holding period T2 (step S21). In this case, the event management device 10 registers a participation history indicating that User a participated in Event A (step S22). Specifically, the event management device 10 changes the status of User a in the user registration table 112A from “Permitted to participate” to “Participate”.

When the holding period T2 ends, the event management device 10 changes the status of the user of whom the status is “Permitted to participate” in the user registration table 112A, that is, the user who has not performed the participation procedure in the holding period T2 despite the permission of the participation in Event A, from “Permitted to participate” to “Permitted not to participate”. “Permitted not to participate” is an example of the third stage according to the present invention. In this example, the event management device 10 changes the status of User c in the user registration table 112A from “Permitted to participate” to “Permitted not to participate”.

Subsequently, on the next day of the holding period T2, the event management device 10 transmits a fourth message to the message destination of each user (User c in this example) of which the status is “Permitted not to participate” in the user registration table 112A (step S23). The fourth message includes a message for calling attention about participation in a future event. In this example, the fourth message is received by the user terminal 20C, and User c is notified of content of the fourth message by displaying a screen or the like.

Accordingly, attention can be called for User c regarding participation in the future event. Therefore, it is possible to inhibit the user from not participating in the future event due to forgetting, to improve efficiency of holding the event, and to inhibit the increase in the load and the network traffic in the service-side system (for example, the event management device 10).

In this example, the configuration has been described in which the fourth message is transmitted to User c who has not performed the participation procedure in the holding period T2 despite permission of the participation in Event A on the next day of the holding period T2, but a transmission timing of the fourth message is not limited to the next day. For example, in addition to the day after the holding period T2 or instead of the day after the holding period T2, the event management device 10 may transmit the fourth message to User c when User c makes an application (for example, a participation request by the user terminal 20C) for another event next time.

As described above, the event management device 10 is configured to be able to manage the status of the user and notify of a message corresponding to the status of the user. Accordingly, for example, by transmitting a predetermined reminder message to the user in “Applied” or “Permitted to participate” at a predetermined time, it is possible to improve convenience for the user.

The event management device 10 can manage the status of the user in a plurality of stages. For example, the event management device 10 manages the status of the user in a plurality of stages of “Applied”. “Permitted to participate”, and “Permitted not to participate” (or to “Participate”).

The event management device 10 performs control such that the status of the user is changeable in one of a plurality of stages over time. For example, the event management device 10 sets the status of the user to “Applied” during the application period T1 of Event A, sets the status of the user who has performed and won the lottery at the time and date of winning announcement of Event A to “Permitted to participate”, sets the status of the user who has performed the participation procedure to “Participate” in the holding period T2, and sets the status of the user of whom the status is “Permitted to participate” to “Permitted not to participate” after the holding period T2.

The event management device 10 performs control such that the user is able to apply for participation in the event. For example, the event management device 10 receives a participation request from the user terminals 20A, 20B, and 20C during the application period T1 of Event A.

The event management device 10 performs control such that the status of the user is changeable for one applied event. For example, the event management device 10 performs control such that the status of the user is changeable for Event A.

The event management device 10 performs control in a plurality of events such that the status of the same user is changeable for each event. For example, when there is an application from the same user for each of Events A, B, . . , the event management device 10 manages the status of the user for each of Events A, B, . . . .

The event management device 10 performs control such that the user of whom the status is the first stage is able to be notified of the first message. For example, the event management device 10 notifies the user of whom the status is “Applied” (a stage in which the user has made an application for participation in the event) of the first message including the date and time of winning announcement (an announcement time of presence or absence of permission of participation in the event).

The event management device 10 performs control such that the user of whom the status is the second stage is able to be notified of the second message. For example, the event management device 10 notifies a user of whom the status is “Permitted to participate” (a stage in which the user is permitted to participate in the event) of the second message including information indicating that the participation is permitted.

The event management device 10 performs control such that the number of second-stage users associated with one event is smaller than the number of first-stage users associated with one event. For example, the event management device 10 executes lottery processing for selecting a second-stage user from the first-stage users.

The event management device 10 performs control such that the first message is able to be notified of a first time before a scheduled notification time of the second message. For example, the event management device 10 notifies the first message 6 hours before the scheduled notification time of the second message.

The event management device 10 performs control such that the second-stage user is able to be notified of the third message 2 hours before the start time of the event. For example. 3 hours before the start time of the event, the event management device 10 notifies a user of whom the status is “Permitted to participate” (a stage in which the user is permitted to participate in the event) of the third message including the date and time of the event.

The event management device 10 performs control such that the user of whom the status is the third stage is able to be notified of the fourth message. For example, the event management device 10 notifies a user of whom the status is “Permitted not to participate” (a stage in which participation in the event is permitted but the user has not participated in the event) of the fourth message including attention calling in participation in the future event.

For example, the event management device 10 notifies the fourth message at a predetermined time (for example, the next day of the event) after the end of the holding period of the event. The event management device 10 notifies of the fourth message when an application for another event is made.

The event management method described in the above-described embodiment can be implemented by executing a prepared event management program on a computer. The event management program is recorded on a computer-readable storage medium and read from the storage medium to be executed. The event management program may be provided in a form stored in a non-transitory storage medium such as a flash memory or may be provided via a network such as the Internet. The computer that executes the event management program may be included in the event management device, may be included in an electronic device such as a smartphone, a tablet terminal, or a personal computer that can communicate with the event management device, or may be included in a server device that can communicate with the event management device and the electronic device.

As described above, the following matters are described in the present specification.

(1)

An event management device connected to be able to communicate with a user terminal, the event management device including:
a management unit configured to be able to manage a status of a user;
a notification unit configured to be able to notify a user of a message; and
a control unit configured to be able to control the management unit and the notification unit.
in which the control unit performs control such that a message in accordance with the status of the user is notifiable.
   (2)

The event management device according to (1), in which
the management unit is able to manage the status in a plurality of stages.
   (3)

The event management device according to (1) or (2), in which
the control unit performs control such that the status is changeable in one of a plurality of stages over time.
   (4)

The event management device according to any one of (1) to (3), in which the control unit performs control such that the user is able to apply for participation in an event.

(5)

The event management device according to any one of (1) to (4), in which
the control unit performs control in one applied event such that the status is changeable.
   (6)

The event management device according to (4) or (5), in which
the control unit performs control in a plurality of events such that the status of the same user is changeable for each event.
   (7)

The event management device according to any one of (1) to (6), in which
the control unit performs control such that a user of whom the status is a first stage is able to be notified of a first message.
   (8)

The event management device according to (7), in which
the first stage is a stage in which the user makes an application for participation in the event.
   (9)

The event management device according to (7) or (8), in which
the control unit performs control such that a user of whom the status is a second stage is able to be notified of a second message.
   (10)

The event management device according to (9), in which
the control unit performs control such that the number of users in the second stage is smaller than the number of users in the first stage associated with one event.
   (11)

The event management device according to (9) or (10), further including a lottery unit configured to be able to execute lottery processing, in which
the control unit is able to control the lottery unit, and
the control unit performs control such that the user reaching the second stage by execution of the lottery processing is able to be notified of the second message.
   (12)

The event management device according to any one of (9) to (11), in which
the second stage is a stage in which the user is permitted to participate in the event.
   (13)

The event management device according to any one of (9) to (12), in which
the first message is a message regarding an announcement time of presence or absence of permission of participation in the event.
   (14)

The event management device according to any one of (9) to (13), in which
the second message is a message for permitting participation in the event.
   (15)

The event management device according to any one of (9) to (14), in which
the control unit performs control such that the first message is notifiable a first time before a scheduled notification time of the second message.
   (16)

The event management device according to any one of (9) to (15), in which
the control unit performs control such that a user in the second stage is able to be notified of a third message.
   (17)

The event management device according to (16), in which
the control unit performs control such that the third message is notifiable a second time before a start time of the event.
   (18)

The event management device according to (16) or (17), in which
the third message is a message regarding a date and time of an event.
   (19)

The event management device according to any one of (1) to (18), in which
the control unit performs control such that a user of whom the status is a third stage is able to be notified of a fourth message.
   (20)

The event management device according to (19), in which
the third stage is a stage in which the user is permitted to participate in an event but does not participate in the event.
   (21)

The event management device according to (19) or (20), in which
the control unit performs control such that the fourth message is notifiable when an application for another event is made.
   (22)

The event management device according to any one of (19) to (21), in which
the fourth message is a message for calling attention about participation in a future event.
   (23)

The event management device according to any one of (1) to (22), in which
an event for a competitive game using a physical card is managed.
   (24)

An event management program for a computer connected to be able to communicate with a user terminal, the program causing the computer to function as:
a management unit configured to be able to manage a status of a user;
a notification unit configured to be able to notify a user of a message; and
a control unit configured to be able to control the management unit and the notification unit.
in which the control unit performs control such that a message in accordance with the status of the user is notifiable.
   (25)

An event management system including:
the event management device according to any one of (1) to (23); and the user terminal.

1. An event management device connected to be able to communicate with a user terminal, the event management device comprising:
a management unit configured to be able to manage a status of a user;
a notification unit configured to be able to notify a user of a message; and
a control unit configured to be able to control the management unit and the notification unit,
wherein the control unit performs control such that a message in accordance with the status of the user is notifiable.

2. The event management device according to claim 1, wherein
the management unit is able to manage the status in a plurality of stages.

3. The event management device according to claim 1, wherein
the control unit performs control such that the status is changeable in one of a plurality of stages over time.

4. The event management device according to claim 1, wherein
the control unit performs control such that the user is able to apply for participation in an event.

5. The event management device according to claim 4, wherein
the control unit performs control in one applied event such that the status is changeable.

6. The event management device according to claim 4, wherein
the control unit performs control in a plurality of events such that the status of the same user is changeable for each event.

7. The event management device according to claim 1, wherein
the control unit performs control such that a user of whom the status is a first stage is able to be notified of a first message.

8. The event management device according to claim 7, wherein
the first stage is a stage in which the user makes an application for participation in the event.

9. The event management device according to claim 7, wherein
the control unit performs control such that a user of whom the status is a second stage is able to be notified of a second message.

10. The event management device according to claim 9, wherein
the control unit performs control such that the number of users in the second stage is smaller than the number of users in the first stage associated with one event.

11. The event management device according to claim 9, further comprising a lottery unit configured to be able to execute lottery processing, wherein
the control unit is able to control the lottery unit, and
the control unit performs control such that the user reaching the second stage by execution of the lottery processing is able to be notified of the second message.

12. The event management device according to claim 9, wherein
the second stage is a stage in which the user is permitted to participate in the event.

13. The event management device according to claim 9, wherein
the first message is a message regarding an announcement time of presence or absence of permission of participation in the event.

14. The event management device according to claim 9, wherein
the second message is a message for permitting participation in the event.

15. The event management device according to claim 9, wherein
the control unit performs control such that the first message is notifiable a first time before a scheduled notification time of the second message.

16. The event management device according to claim 9, wherein
the control unit performs control such that a user in the second stage is able to be notified of a third message.

17. The event management device according to claim 16, wherein
the control unit performs control such that the third message is notifiable a second time before a start time of the event.

18. The event management device according to claim 16, wherein
the third message is a message regarding a date and time of an event.

19. The event management device according to claim 1, wherein
the control unit performs control such that a user of whom the status is a third stage is able to be notified of a fourth message.

20. The event management device according to claim 19, wherein
the third stage is a stage in which the user is permitted to participate in an event but does not participate in the event.

21. The event management device according to claim 19, wherein
the control unit performs control such that the fourth message is notifiable when an application for another event is made.

22. The event management device according to claim 19, wherein
the fourth message is a message for calling attention about participation in a future event.

23. The event management device according to claim 1, wherein
an event for a competitive game using a physical card is managed.

24. An event management program for a computer connected to be able to communicate with a user terminal, the program causing the computer to function as:
a management unit configured to be able to manage a status of a user,
a notification unit configured to be able to notify a user of a message; and
a control unit configured to be able to control the management unit and the notification unit,
wherein the control unit performs control such that a message in accordance with the status of the user is notifiable.

25. An event management system comprising:
the event management device according to claim 1; and
the user terminal.
